(19) United States
(12) Patent Application Publication
(10) Pub. No.: US 2018/0007544 A1
(43) Pub. Date: Jan. 4, 2018

(54) METHODS AND APPARATUSES FOR CONFIGURING A BLE ADVERTISING BEACON

(71) Applicant: Nokia Technologies Oy, Espoo (FI)

(72) Inventor: Guido Grassel, Espoo (FI)

(21) Appl. No.: 15/540,599

(22) PCT Filed: Dec. 31, 2014
(86) PCT No.: PCT/IB2014/067453

§ 371 Date: Jun. 29, 2017

(51) Int. Cl. H04W 8/24; H04W 4/00; G06K 19/06; H04W 4/20; G06K 7/14

(52) U.S. Cl. CPC H04W 8/245; H04W 4/206; G06K 7/1413; G06K 19/06028; H04W 4/008

(57) ABSTRACT

A method, apparatus, and computer program product are provided in order to provide improvements in the configuring of Bluetooth low energy (BLE) advertising beacons. Embodiments of the present invention are directed to conveniently and reliably configuring or updating the configuration of a BLE beacon, while limiting the amount of technical information and/or tools required. A method is provided comprising: receiving a data stream encoded in a flickering barcode from a programming device; decoding, using a processor, the received data stream; and configuring a BLE beacon advertisement using the decoded data stream. The method may further include transmitting the configured BLE beacon advertisement. A corresponding apparatus and a computer program product are also provided.

### TECHNOLOGICAL FIELD

An example embodiment of the present invention relates generally to Bluetooth low energy (BLE) beacons, and more specifically, to providing for improvements in the configuring of BLE advertising beacons.

### BACKGROUND

A number of deficiencies and problems associated with configuring Bluetooth low energy (BLE) advertising beacons are identified herein. Through applied effort, ingenuity, and innovation, example solutions to many of these identified problems are embodied by the present invention, which is described in detail below.

A BLE beacon device can be used to broadcast small amounts of data, for example, a uniform resource identifier (URI) for an advertisement. The broadcast data is typically static, that is, the same data is broadcast until the next time the beacon advertisement is changed. Any BLE observer device, for example, a smartphone, can receive and use the broadcast data as long as it is aware of the syntax and semantics of the data. For example, the BLE observer device can use the data (for example, a URI) to access a webpage of a merchant operating the BLE beacon.

Before a BLE beacon device can be used, for example to broadcast a URI for advertising merchant information, the BLE beacon device must be configured with the data which is to be broadcast (for example, the URI).

### BRIEF SUMMARY

Methods, apparatuses, and computer program products are therefore provided according to example embodiments of the present invention to provide for improvements in the configuring of BLE advertising beacons. Embodiments of the present invention are directed to conveniently and reliably configuring or updating the configuration of a BLE beacon, while limiting the amount of technical information and/or tools required.

In one embodiment, a method is provided that at least includes receiving a data stream encoded in a flickering barcode from a programming device; decoding, using a processor, the received data stream; and configuring a Bluetooth low energy beacon advertisement using the decoded data stream.

In some embodiments, the method further comprises transmitting the configured Bluetooth low energy beacon advertisement.

In some embodiments, the method further comprises activating a light sensor array for use in receiving the flickering barcode. In some embodiments, the method further comprises wherein the light sensor array is activated after receiving an indication from a user.

In some embodiments, the method further comprises causing transmission of a Bluetooth low energy advertisement message to the programming device to begin display of the flickering barcode.

In some embodiments, the method further comprises determining if the data stream encoded in the flickering barcode was received successfully or if the flickering barcode transmission failed; and causing an indication to be provided of the success or failure of receiving the data stream. In some embodiments, the method further comprises causing transmission of a Bluetooth low energy advertisement message to the programming device indicating the success or failure of receiving the data stream.

In some embodiments, the method further comprises wherein the programming device observes the configured Bluetooth low energy beacon advertisement and verifies that the advertisement is correct, wherein the verification comprises comparing the observed advertisement with the data stream encoded in the flickering barcode by the programming device.

In another embodiment, an apparatus is provided that includes at least one processor and at least one memory including computer program instructions with the at least one memory and the computer program instructions configured to, with the at least one processor, cause the apparatus at least to receive a data stream encoded in a flickering barcode from a programming device; decode the received data stream; and configure a Bluetooth low energy beacon advertisement using the decoded data stream.

In some embodiments, the apparatus further comprises the at least one memory and the computer program instructions being further configured to, with the at least one processor, cause the apparatus to transmit the configured Bluetooth low energy beacon advertisement.

In some embodiments, the apparatus further comprises the at least one memory and the computer program instructions being further configured to, with the at least one processor, cause the apparatus to activate a light sensor array for use in receiving the flickering barcode. In some embodiments, the apparatus further comprises the at least one memory and the computer program instructions being further configured to, with the at least one processor, cause the apparatus to activate the light sensor array after receiving an indication from a user.

In some embodiments, the apparatus further comprises the at least one memory and the computer program instructions being further configured to, with the at least one processor, cause the apparatus to cause transmission of a Bluetooth low energy advertisement message to the programming device to begin display of the flickering barcode.

In some embodiments, the apparatus further comprises the at least one memory and the computer program instructions being further configured to, with the at least one processor, cause the apparatus to determine if the data stream encoded in the flickering barcode was received successfully or if the flickering barcode transmission failed; and cause an indication to be provided of the success or failure of receiving the data stream. In some embodiments, the apparatus further comprises the at least one memory and the computer program instructions being further configured to, with the at least one processor, cause the apparatus to cause transmission of a Bluetooth low energy advertisement message to the programming device indicating the success or failure of receiving the data stream.

In another embodiment, a computer program product is provided that includes at least one non-transitory computer-readable storage medium bearing computer program instructions embodied therein for use with a computer, with the computer program instructions including program instructions configured to cause the computer at least to receive a data stream encoded in a flickering barcode from a programming device; decode the received data stream; and configure a Bluetooth low energy beacon advertisement using the decoded data stream.

In some embodiments, the computer program product further comprises program instructions configured to cause the computer at least to transmit the configured Bluetooth low energy beacon advertisement.

In some embodiments, the computer program product further comprises program instructions configured to cause the computer at least to activate a light sensor array for use in receiving the flickering barcode. In some embodiments, the computer program product further comprises program instructions configured to cause the computer at least to activate the light sensor array after receiving an indication from a user.

In some embodiments, the computer program product further comprises program instructions configured to cause the computer at least to cause transmission of a Bluetooth low energy advertisement message to the programming device to begin display of the flickering barcode.

In some embodiments, the computer program product further comprises program instructions configured to cause the computer at least to determine if the data stream encoded in the flickering barcode was received successfully or if the flickering barcode transmission failed; and cause an indication to be provided of the success or failure of receiving the data stream. In some embodiments, the computer program product further comprises program instructions configured to cause the computer at least to cause transmission of a Bluetooth low energy advertisement message to the programming device indicating the success or failure of receiving the data stream.

In another embodiment, an apparatus is provided that includes at least means for receiving a data stream encoded in a flickering barcode from a programming device; means for decoding the received data stream; and means for configuring a Bluetooth low energy beacon advertisement using the decoded data stream.

In some embodiments, the apparatus further comprises means for transmitting the configured Bluetooth low energy beacon advertisement.

In some embodiments, the apparatus further comprises means for activating a light sensor array for use in receiving the flickering barcode. In some embodiments, the apparatus further comprises wherein the light sensor array is activated after receiving an indication from a user.

In some embodiments, the apparatus further comprises means for causing transmission of a Bluetooth low energy advertisement message to the programming device to begin display of the flickering barcode.

In some embodiments, the apparatus further comprises means for determining if the data stream encoded in the flickering barcode was received successfully or if the flickering barcode transmission failed; and means for causing an indication to be provided of the success or failure of receiving the data stream. In some embodiments, the apparatus further comprises means for causing transmission of a Bluetooth low energy advertisement message to the programming device indicating the success or failure of receiving the data stream.

In another embodiment, a method is provided that at least includes receiving data via a user interface; generating, using a processor, a flickering barcode based on the received data; and causing the flickering barcode to be displayed on a display, wherein the data encoded in the flickering barcode is used to configure a Bluetooth low energy beacon advertisement.

In some embodiments, the method further comprises wherein the received data comprises a uniform resource identifier for use in configuring the Bluetooth low energy beacon advertisement.

In some embodiments, the method further comprises using a uniform resource identifier shortener service to shorten the uniform resource identifier provided in the received data.

In some embodiments, the method further comprises causing the received data to be displayed; and receiving an indication that the displayed data is the intended data for use in configuring the Bluetooth low energy beacon advertisement.

In some embodiments, the method further comprises receiving a message indicating that display of the flickering barcode should be displayed, wherein the message is a special Bluetooth low energy beacon advertisement from a Bluetooth low energy beacon to be configured; and causing the flickering barcode to be displayed on a display as a result of receiving the message.

In some embodiments, the method further comprises receiving indication of whether the flickering barcode has been received properly by a Bluetooth low energy beacon; and if the flickering barcode was received properly, causing display of the flickering barcode to be stopped; and if the flickering barcode was not received properly, causing display of the flickering barcode to be restarted.

In some embodiments, the method further comprises causing an indication of the success or failure of the flickering barcode transmission to be displayed on a display of a user interface.

In some embodiments, the method further comprises receiving a Bluetooth low energy advertisement; and verifying that data received in the Bluetooth low energy advertisement is correct based on a comparison to the data used to generate the flickering barcode.

In another embodiment, a method is provided that at least includes receiving a data stream encoded in a flickering barcode from a programming device; decoding, using a processor, the received data stream; and loading an encryption key for a Bluetooth low energy beacon using the decoded data stream.

In some embodiments, the method further comprises using the loaded encryption key to encrypt Bluetooth low energy beacon advertisements.

In another embodiment, a method is provided that at least includes receiving a data stream encoded in a flickering barcode from a programming device; decoding, using a processor, the received data stream; and configuring a Bluetooth low energy beacon using the decoded data stream.

In some embodiments, the method further comprises wherein the decoded data stream comprises configuration data for an application running on the Bluetooth low energy beacon.

In another embodiment, an apparatus is provided that includes at least one processor and at least one memory including computer program instructions with the at least one memory and the computer program instructions configured to, with the at least one processor, cause the apparatus at least to receive data via a user interface; generate a flickering barcode based on the received data; and cause the flickering barcode to be displayed on a display, wherein the data encoded in the flickering barcode is used to configure a Bluetooth low energy beacon advertisement.

In some embodiments, the apparatus further comprises wherein the received data comprises a uniform resource identifier for use in configuring the Bluetooth low energy beacon advertisement.

In some embodiments, the apparatus further comprises the at least one memory and the computer program instructions being further configured to, with the at least one processor, cause the apparatus to use a uniform resource identifier shortener service to shorten the uniform resource identifier provided in the received data.

In some embodiments, the apparatus further comprises the at least one memory and the computer program instructions being further configured to, with the at least one processor, cause the apparatus to cause the received data to be displayed; and receive an indication that the displayed data is the intended data for use in configuring the Bluetooth low energy beacon advertisement.

In some embodiments, the apparatus further comprises the at least one memory and the computer program instructions being further configured to, with the at least one processor, cause the apparatus to receive a message indicating that display of the flickering barcode should be displayed, wherein the message is a special Bluetooth low energy beacon advertisement from a Bluetooth low energy beacon to be configured; and cause the flickering barcode to be displayed on a display as a result of receiving the message.

In some embodiments, the apparatus further comprises the at least one memory and the computer program instructions being further configured to, with the at least one processor, cause the apparatus to receive indication of whether the flickering barcode has been received properly by a Bluetooth low energy beacon; and if the flickering barcode was received properly, cause display of the flickering barcode to be stopped; and if the flickering barcode was not received properly, cause display of the flickering barcode to be restarted.

In some embodiments, the apparatus further comprises the at least one memory and the computer program instructions being further configured to, with the at least one processor, cause the apparatus to cause an indication of the success or failure of the flickering barcode transmission to be displayed on a display of a user interface.

In some embodiments, the apparatus further comprises the at least one memory and the computer program instructions being further configured to, with the at least one processor, cause the apparatus to receive a Bluetooth low energy advertisement; and verify that data received in the Bluetooth low energy advertisement is correct based on a comparison to the data used to generate the flickering barcode.

In another embodiment, an apparatus is provided that includes at least one processor and at least one memory including computer program instructions with the at least one memory and the computer program instructions configured to, with the at least one processor, cause the apparatus at least to receive a data stream encoded in a flickering barcode from a programming device; decode the received data stream; and load an encryption key for a Bluetooth low energy beacon using the decoded data stream.

In some embodiments, the apparatus further comprises the at least one memory and the computer program instructions being further configured to, with the at least one processor, cause the apparatus to use the loaded encryption key to encrypt Bluetooth low energy beacon advertisements.

In another embodiment, an apparatus is provided that includes at least one processor and at least one memory including computer program instructions with the at least one memory and the computer program instructions configured to, with the at least one processor, cause the apparatus at least to receive a data stream encoded in a flickering barcode from a programming device; decode the received data stream; and configure a Bluetooth low energy beacon using the decoded data stream.

In some embodiments, the apparatus further comprises wherein the decoded data stream comprises configuration data for an application running on the Bluetooth low energy beacon.

In some embodiments, the computer program product further comprises program instructions configured to cause the computer at least to

In another embodiment, a computer program product is provided that includes at least one non-transitory computer-readable storage medium bearing computer program instructions embodied therein for use with a computer, with the computer program instructions including program instructions configured to cause the computer at least to receive data via a user interface; generate a flickering barcode based on the received data; and cause the flickering barcode to be displayed on a display, wherein the data encoded in the flickering barcode is used to configure a Bluetooth low energy beacon advertisement.

In some embodiments, the computer program product further comprises wherein the received data comprises a uniform resource identifier for use in configuring the Bluetooth low energy beacon advertisement.

In some embodiments, the computer program product further comprises program instructions configured to cause the computer at least to use a uniform resource identifier shortener service to shorten the uniform resource identifier provided in the received data.

In some embodiments, the computer program product further comprises program instructions configured to cause the computer at least to cause the received data to be displayed; and receive an indication that the displayed data is the intended data for use in configuring the Bluetooth low energy beacon advertisement.

In some embodiments, the computer program product further comprises program instructions configured to cause the computer at least to receive a message indicating that display of the flickering barcode should be displayed, wherein the message is a special Bluetooth low energy beacon advertisement from a Bluetooth low energy beacon to be configured; and cause the flickering barcode to be displayed on a display as a result of receiving the message.

In some embodiments, the computer program product further comprises program instructions configured to cause the computer at least to receive indication of whether the flickering barcode has been received properly by a Bluetooth low energy beacon; and if the flickering barcode was received properly, cause display of the flickering barcode to be stopped; and if the flickering barcode was not received properly, cause display of the flickering barcode to be restarted.

In some embodiments, the computer program product further comprises program instructions configured to cause the computer at least to cause an indication of the success or failure of the flickering barcode transmission to be displayed on a display of a user interface.

In some embodiments, the computer program product further comprises program instructions configured to cause the computer at least to receive a Bluetooth low energy advertisement; and verify that data received in the Bluetooth low energy advertisement is correct based on a comparison to the data used to generate the flickering barcode.

In another embodiment, a computer program product is provided that includes at least one non-transitory computer-readable storage medium bearing computer program instructions embodied therein for use with a computer, with the computer program instructions including program instructions configured to cause the computer at least to receive a data stream encoded in a flickering barcode from a programming device; decode the received data stream; and load an encryption key for a Bluetooth low energy beacon using the decoded data stream.

In some embodiments, the computer program product further comprises program instructions configured to cause the computer at least to use the loaded encryption key to encrypt Bluetooth low energy beacon advertisements.

In another embodiment, a computer program product is provided that includes at least one non-transitory computer-readable storage medium bearing computer program instructions embodied therein for use with a computer, with the computer program instructions including program instructions configured to cause the computer at least to receive a data stream encoded in a flickering barcode from a programming device; decode the received data stream; and configure a Bluetooth low energy beacon using the decoded data stream.

In some embodiments, the computer program product further comprises wherein the decoded data stream comprises configuration data for an application running on the Bluetooth low energy beacon.

In another embodiment, an apparatus is provided that includes at least means for receiving data via a user interface; means for generating a flickering barcode based on the received data; and means for causing the flickering barcode to be displayed on a display, wherein the data encoded in the flickering barcode is used to configure a Bluetooth low energy beacon advertisement.

In some embodiments, the apparatus further comprises wherein the received data comprises a uniform resource identifier for use in configuring the Bluetooth low energy beacon advertisement.

In some embodiments, the apparatus further comprises means for using a uniform resource identifier shortener service to shorten the uniform resource identifier provided in the received data.

In some embodiments, the apparatus further comprises means for causing the received data to be displayed; and means for receiving an indication that the displayed data is the intended data for use in configuring the Bluetooth low energy beacon advertisement.

In some embodiments, the apparatus further comprises means for receiving a message indicating that display of the flickering barcode should be displayed, wherein the message is a special Bluetooth low energy beacon advertisement from a Bluetooth low energy beacon to be configured; and means for causing the flickering barcode to be displayed on a display as a result of receiving the message.

In some embodiments, the apparatus further comprises means for receiving indication of whether the flickering barcode has been received properly by a Bluetooth low energy beacon; and if the flickering barcode was received properly, means for causing display of the flickering barcode to be stopped; and if the flickering barcode was not received properly, means for causing display of the flickering barcode to be restarted.

In some embodiments, the apparatus further comprises means for causing an indication of the success or failure of the flickering barcode transmission to be displayed on a display of a user interface.

In some embodiments, the apparatus further comprises means for receiving a Bluetooth low energy advertisement; and means for verifying that data received in the Bluetooth low energy advertisement is correct based on a comparison to the data used to generate the flickering barcode.

In another embodiment, an apparatus is provided that includes at least means for receiving a data stream encoded in a flickering barcode from a programming device; means for decoding the received data stream; and means for loading an encryption key for a Bluetooth low energy beacon using the decoded data stream.

In some embodiments, the apparatus further comprises means for using the loaded encryption key to encrypt Bluetooth low energy beacon advertisements.

In another embodiment, an apparatus is provided that includes at least means for receiving a data stream encoded in a flickering barcode from a programming device; means for decoding the received data stream; and means for configuring a Bluetooth low energy beacon using the decoded data stream.

In some embodiments, the apparatus further comprises wherein the decoded data stream comprises configuration data for an application running on the Bluetooth low energy beacon.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 illustrates a block diagram of an apparatus that may be specifically configured in accordance with example embodiments of the present invention;

FIG. 2 illustrates a flow chart of operations for configuring a BLE beacon performed by an apparatus in accordance with an example embodiment of the present invention;

FIG. 3 illustrates an example of proper alignment of a BLE beacon's light sensor array in accordance with an example embodiment of the present invention;

FIG. 4 illustrates a flowchart of operations for configuring a BLE beacon performed by an apparatus in accordance with an example embodiment of the present invention; and

FIGS. 5A to 5B illustrate example systems in accordance with example embodiments of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

Method, apparatuses, and computer program products are provided in accordance with example embodiments of the present invention to provide for improvements in configuring of Bluetooth Low Energy (BLE) beacons.

### Example Apparatus

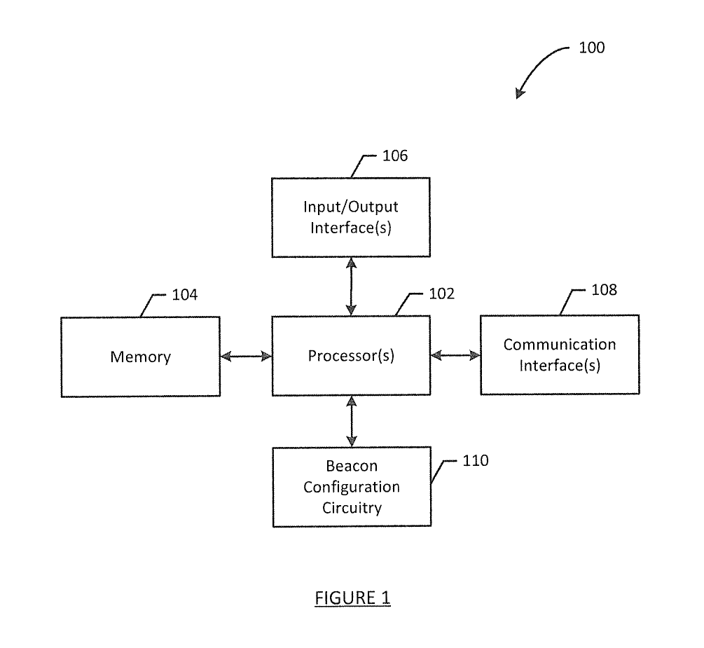

Referring to FIG. 1, an apparatus 100 for configuring BLE advertising beacons in accordance with an example embodiment may include or otherwise be in communication with one or more of at least one processor 102, at least one memory 104, at least one communication interface 106, at least one input/output interface 108, and a beacon configuration module 110.

It should be noted that while FIG. 1 illustrates one example of a configuration of an apparatus 100 for configuring BLE advertising beacons, numerous other configurations may also be used to implement other embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor (and/or co-processors or any other processing circuitry assisting or otherwise associated with the processor) may be in communication with the memory 104 via a bus for passing information among components of the apparatus. The memory 104 may include, for example, a non-transitory memory, such as one or more volatile and/or non-volatile memories. In other words, for example, the memory 104 may be an electronic storage device (for example, a computer readable storage medium) comprising gates configured to store data (for example, bits) that may be retrievable by a machine (for example, a computing device like the processor). The memory 104 may be configured to store information, data, content, applications, instructions, or the like for enabling the apparatus to carry out various functions in accordance with an example embodiment of the present invention. For example, the memory 104 could be configured to buffer input data for processing by the processor 102. Additionally or alternatively, the memory could be configured to store instructions for execution by the processor.

In some embodiments, the apparatus 100 may be embodied as a chip or chip set. In other words, the apparatus may comprise one or more physical packages (for example, chips) including materials, components, and/or wires on a structural assembly (for example, a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 102 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 102 may be configured to execute instructions stored in the memory 104 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU), and logic gates configured to support operation of the processor.

The communication interface 106 may be any means such as a device or circuitry embodied in either hardware or a combination of hardware and software that is configured to receive and/or transmit data from/to a network and/or any other device or module in communication with the apparatus 100. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB), Ethernet, High-Definition Multimedia Interface (HDMI), or other mechanisms. Furthermore, the communication interface 106 may include hardware and/or software for supporting communication mechanisms such as BLUETOOTH®, Infrared, UWB, WiFi, and/or the like.

The apparatus 100 may include an input/output interface 108 that may, in turn, be in communication with the processor 102 to receive input from and to provide output to a user. For example, the input/output interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more input/output interface elements such as a display and, in some embodiments, a speaker, ringer, microphone, and/or the like. The processor and/or user interface circuitry comprising the processor may be configured to control one or more functions of one or more input/output interface elements through computer program instructions (for example, software and/or firmware) stored on a memory accessible to the processor (for example, memory 104 and/or the like).

The apparatus 100 may include beacon configuration circuitry 110. In some embodiments, the beacon configuration circuitry 110 may comprise, or be in communication with, an array of light sensors, or photodetectors, capable of receiving/reading a data stream such as a flickering barcode displayed on a display screen of a programming device, for example, a smartphone, tablet, laptop computer, or the like. In some embodiments, the beacon configuration circuitry 110 may comprise, or be in communication with, a programmable near field communication (NFC) tag capable of receiving a message/data from an NFC writer, for example, a NFC-capable smartphone, tablet, laptop computer, or the like. The beacon configuration circuitry 110 may be configured to receive and/or decode a data stream and use the data in configuring a Bluetooth low energy (BLE) advertising beacon. The beacon configuration circuitry 110 may be implemented using hardware components of apparatus 100 configured by either hardware or software for implementing these features. For example, beacon configuration circuitry 110 may utilize processing circuitry, such as processor 102 and memory 104, to perform such operations.

### Overview

A BLE beacon can be used to broadcast small amounts of arbitrary data, for example a uniform resource identifier (URI) for an advertisement. Any BLE observer device, for example a smartphone, can receive and use the broadcast data as long as it is aware of the syntax and semantics of the data. For example, the BLE observer device can use the broadcast data (for example, URI) to access a webpage of an entity (for example, a merchant) operating the BLE beacon.

Before a BLE beacon device can be used, for example to broadcast a URI for advertising merchant information, the BLE beacon device must be configured with the data which is to be broadcast. Embodiments of the present invention are directed to methods and apparatuses to conveniently and reliably configure or update the configuration of a BLE beacon, while limiting the amount of technical information and/or tools required.

For example, upon purchasing and installing a BLE beacon device, a merchant must configure the BLE beacon device with data (for example, a URI) to direct observers to a webpage for the merchant. Additionally, should the merchant wish to change the advertising being broadcast by the BLE beacon (for example, broadcast a URI for a different webpage), the merchant must update the configuration of the BLE beacon device.

Generally, configuring of a BLE beacon is done by connecting the beacon device, either with wires or wirelessly, to a programming device, such as a computer or smartphone. Wireless programming can involve pairing the beacon device with a computer or smartphone and making a point-to-point BLE connection. In both wired and wireless cases, a compatible application is required which provides the end-point of the connection on the programming device to perform the configuration operations. Furthermore, in a scenario involving multiple BLE beacon devices, the operator needs to correctly identify each beacon before performing the configuration. Embodiments of the present invention using flickering barcode provide an alternate means of configuring where neither a wired connection nor a wireless connection between the programming device and the BLE beacon is used to configure the beacon advertisement.

### Flickering Barcode

Some embodiments of the present invention incorporate into a BLE beacon device the ability to use a flickering barcode transfer mechanism to receive data and then utilize this data to configure the beacon advertisement. Flickering barcodes can be used to transfer data from a first device (for example, computer, smartphone, or the like) to a reader device that is equipped with an array of light sensors or photodetectors. For the data transfer, the array of photodetectors of the reader device is placed in a stationary position above the display screen of the first device. In some embodiments, a flickering barcode may be displayed using an array of light sources of the first device, such as, for example, an array of light emitting diodes (LEDs), and the photodetectors of the reader device would be placed in a stationary position above the array of light sources of the first device. Using the array of photodetectors, the reader device can read a data stream off the display screen encoded in the flickering barcode. The number of bits of information that can be read at once is based on the number of light sensors in the array. The frame rate at which new information is shown on the display screen (the rate of flickering) can be up to several times per second. The number of frames of the flickering barcode is dependent on the number of light sensors on the light sensor/reading device, the amount of data to be transmitted, etc. For example, the light sensor/reading device requires a separate light sensor/photodetector for each bar/spot position in the flickering barcode display. As used above, a “frame” of the flickering barcode is considered to be a single image of the barcode comprising a set of light and dark bars/spots that encode a particular sequence of data bits. The flickering barcode then comprises the set of frames displayed in sequence that comprise all the data to be transferred by the flickering barcode, including any overhead data added, for example, for use in error detection and correction. The number of frames of the flickering barcode would be dependent on the total amount of data to be transferred in light of the amount of data that can be encoded in a single frame.

In some embodiments, for example, a programming device, for example, a smartphone, tablet, computer, or the like, is used to obtain a URI (for example, from a user) and the URI is encoded in a flickering barcode which is displayed on a display of the programming device. For example, a programming user may enter the URI on the programming device via a user interface or may select a webpage displayed in a browser. In some embodiments, since BLE beacon advertisements are limited in size, the programming device may utilize a URI shortener service to provide a shortened URI from the URI entered by the user. In some embodiments, the URI entered by the user may be translated into a compressed representation, for example where the substrings “http://www”, “https://www”, or the top level domain have a compressed representation. The light sensor array of the BLE beacon, or a sensor device associated with the BLE beacon, is positioned over the flickering barcode and the BLE beacon reads the data stream from the flickering barcode. Once the BLE beacon has successfully read the entire data stream, the BLE beacon uses the data (for example, the URI) to configure the beacon's advertisement and may then begin broadcasting the new advertisement (for example, a URI for a particular webpage).

In some embodiments, the light sensor array may not be comprised in the BLE beacon device, but instead a separate light sensor device that is capable of receiving a flickering barcode data stream may be associated with the BLE beacon. For example, a photo sensor array device may be provided that can be associated with a BLE beacon device (for example, physically attached to the BLE beacon) and then used for configuring the BLE beacon. In some embodiments, such a photo sensor array device may be detachable such that it is only attached to the BLE beacon device during configuration of the BLE beacon device and thus may be used to configure multiple BLE beacon devices. In some embodiments, the photo sensor array device may include a processor and memory for performing operations for reading and decoding a flickering barcode and may communicate with the BLE beacon via a communication interface, such as, for example, a serial peripheral interface (SPI) or an inter-integrated circuit (I2C) interface.

Embodiments may provide for easier and more secure configuration by only requiring a smartphone or the like as a programming device, removing the need for the BLE beacon to support USB cable connections or a BLE GATT peripheral role for programming, and by simplifying securing the BLE beacon from unauthorized reconfiguration by requiring physical access to the BLE beacon. In addition, using embodiments disclosed herein, selecting the correct BLE beacon to be configured from amongst several co-located BLE beacons is more reliable as compared to wireless configuration solutions.

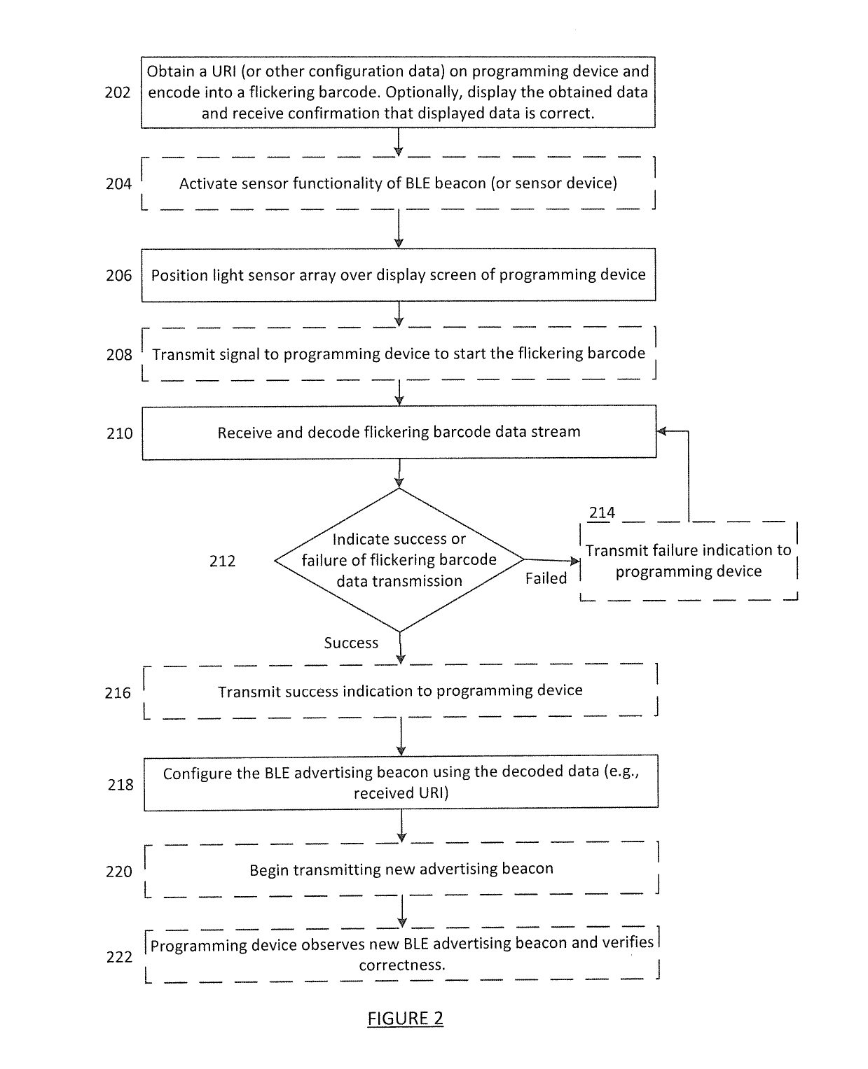

FIG. 2 illustrates a flowchart of operations for configuring a BLE advertising beacon performed by an apparatus, such as apparatus 100, in accordance with an example embodiment of the present invention. At block 202, a programming device (for example, a smartphone, tablet, computer, or the like with a display screen) obtains a URI, or other data, to be used in configuring the BLE advertising beacon. For example, a programming user enters the URI on the programming device via a user interface or selects a webpage displayed in a browser. In some cases, since BLE beacon advertisements are limited in size, the programming device may utilize a URI shortener service to provide a shortened URI from the URI entered by the user. Optionally, in some embodiments, the received data may be displayed, for example on a user interface of the programming device, and an indication may be received from the programming user that the displayed data to be used in configuring the BLE beacon advertisement is correct. The programming device may then encode the URI into a flickering barcode.

Optionally, at block 204, the light sensing functionality of the BLE beacon, or associated sensor device, may be activated, using means, such as the processor 102, memory 104, input/output interface 106, beacon configuration circuitry 110, or the like, for example, upon receiving an indication from a user. For example, in some embodiments, the light sensor functions of the BLE beacon may be switched off when not needed (for example, when not being used for configuration) to preserve energy and is only activated for the duration of the configuration operations. In some embodiments, the light sensor functionality of the BLE beacon may be activated by use of a physical switch.

At bock 206, the light sensor array of the BLE beacon, or associated sensor device, is properly positioned over the display screen of the programming device. For example, the BLE beacon's light sensor array may include alignment markers to ensure proper alignment of the light sensor array with the display of the flickering barcode displayed on the programming device. For example, the programming device may also display a set of alignment markers above the flickering barcode such that the programming user may properly align the BLE beacon's light sensor array with the display of the flickering barcode. In some embodiments, the programming device may also provide for adjusting the horizontal and/or vertical size of the flickering barcode display, and the associated alignment markers, to allow for proper alignment.

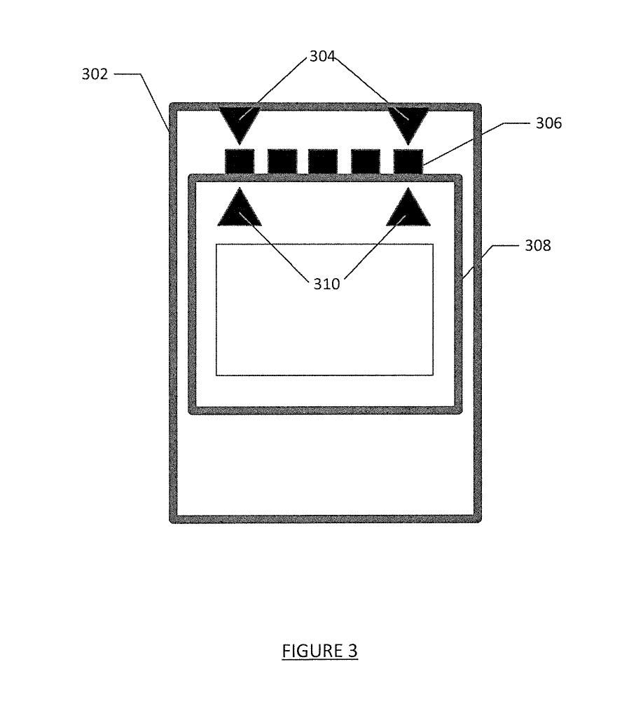

FIG. 3 illustrates an example of the proper alignment of a light sensor array with a 1-dimensional flickering barcode display. FIG. 3 illustrates a programming device display screen 302 which is displaying alignment markers 304 above a flickering barcode 306. The BLE beacon light sensor array 308, or the associated sensor device's light sensor array, includes alignment markers 310. To provide for proper reading of the flickering barcode, the light sensor array's alignment markers 310 are aligned with the programming device display screen alignment markers 304. In embodiments, the programming device may provide for adjusting the flickering barcode display size (and hence the displayed alignment marker positions) to allow for proper alignment of the light sensor array.

Optionally, at block 208, once the light sensor array of the BLE beacon, or associated sensor device, is properly positioned over the display screen, the BLE beacon may transmit a special advertisement that can be observed by the programming device to start transmission of the data stream, for example, to begin the display cycling of the flickering barcode, using means, such as the processor 102, memory 104, communication interface 108, beacon configuration circuitry 110, or the like. For example, in some embodiments, the programming device may not begin displaying the flickering barcode until the BLE beacon indicates it is ready for the transmission, such as by the transmission of the special advertisement. Alternatively, in some embodiments, the programming device may begin displaying the flickering barcode as soon as the data is received and encoded by the programming device without waiting for a signal from the BLE beacon, such as, for example, where the flickering barcode is displayed in a repeating loop. In some embodiments, the flickering barcode may be displayed in a repeating loop fashion to avoid the need for synchronizing on the start of the flickering barcode display.

At block 210, using the light sensor array, the BLE beacon receives and decodes the data, for example, a URI, from the programming device via the flickering barcode. At block 212, the BLE beacon device, using means, such as the processor 102, memory 104, input/output interface 106, beacon configuration circuitry 110, or the like indicates whether the data transmission was successful or if the data transmission failed using suitable indicators, for example, by displaying an indication on a user interface, by lighting an appropriate LED, or the like. For example, the flickering barcode may include some additional data or redundant data that is suitable for transmission error detection by the BLE beacon or associated sensor device.

If the data transfer failed, the BLE beacon, using means, such as the processor 102, memory 104, communication interface 108, beacon configuration circuitry 110, or the like, may optionally transmit a special advertisement to signal the programming device that the transmission has failed and/or request retransmission at block 214. The programming device may then optionally update a user interface or display of the programming device to indicate the failure to the user and respond to the special advertisement accordingly, for example by restarting the flickering barcode, and operation may return to block 210 to retry receiving of the data transfer.

If the data transfer succeeded, the BLE beacon, using means, such as the processor 102, memory 104, communication interface 108, beacon configuration circuitry 110, or the like, may optionally transmit a special advertisement to signal the programming device that the transmission has succeeded at block 216. The programming device may then optionally update a user interface or display of the programming device to indicate the success to the user and respond to the special advertisement accordingly, for example, by stopping display of the flickering barcode.

At block 218, the BLE beacon, using means, such as the processor 102, memory 104, beacon configuration circuitry 110, or the like, uses the received data, for example, the received URI, to configure the beacon advertisement. In the case where the BLE beacon's advertisement configuration is being updated (as opposed to an initial configuration), the BLE beacon may disregard the existing advertisement configuration and replace it using the newly transmitted data. In some embodiments, after receiving the URI, the URI may be translated into a compressed representation, for example where the substrings “http://www”, “https://www”, or the top level domain have a compressed representation.

At block 220, the BLE beacon may begin transmitting the new advertisement. Optionally in some embodiments, the programming device, for example, a smartphone, may observe the newly advertised URI, verify that it is the correct advertisement, and provide an indication such as on its user interface, at block 222.

In some embodiments, the flickering barcode transfer mechanism may be used to load an encryption key on the BLE beacon device whereby encryption may be used for BLE advertisements. As such, only observers that have the pre-shared encryption key would be able to decode and use the BLE advertisements. In some embodiments, the BLE beacon device may have a previously loaded encryption key and the data transferred from the programming device in the flickering barcode may be encrypted with the key before broadcast.

In some embodiments, the flickering barcode transfer mechanism may be used to load other types of configuration data onto the BLE beacon. For example, the transfer mechanism may allow providing other configuration data to an application running on the BLE beacon, such as frequency for reading and broadcasting a sensor value, numeric values/thresholds for alarm conditions, and/or the like.

### Near Field Communication

Some embodiments of the present invention incorporate into a BLE beacon device the ability to receive messages via near field communication (NFC), for example, data that contains a URI, and then utilize this data to configure the beacon's advertisement. Using NFC, NFC tags can be programmed to emit a URI record whenever a NFC reader comes into contact with the tag. Such functionality has been described as part of the NFC Data Exchange Format (NDEF) specification. A smartphone, or similar device, is capable of acting as an NFC writer, for example, it can be used to program an NFC tag with a URI. In addition, two NFC-capable devices can establish a two-way data connection, for example, to exchange standard and/or application-specific messages.

In some embodiments, for example, a programming device, for example, a smartphone, tablet, computer, or the like, is used to obtain a URI (for example, from a user) and the URI is then transmitted to the BLE beacon device using NFC (for example, the programming device acts as an NFC writer). The BLE beacon device includes the functionality of a programmable NFC tag. Once the BLE beacon device has received the message via NFC (for example, the message is written to the NFC tag), the BLE beacon device uses the data in the message (for example, the URI) to configure the BLE beacon's advertisement and may then begin broadcasting the new advertisement (for example, a URI for a particular webpage).

In some embodiments, the NFC reader (NFC tag) may not be comprised in the BLE beacon device, but instead a separate NFC reader device that is capable of receiving messages from a NFC writer may be associated with the BLE beacon. For example, a NFC reader device may be provided that can be associated with a BLE beacon device (for example, physically attached to the BLE beacon) and then used for configuring the BLE beacon. In some embodiments, such a NFC reader device may be detachable such that it is only attached to the BLE beacon device during configuration of the BLE beacon device and thus may be used to configure multiple BLE beacon devices. In some embodiments, the NFC reader device may include a processor and memory for performing operations for receiving NFC messages and may communicate with the BLE beacon via a communication interface, such as, for example, a SPI or I2C interface.

Embodiments may provide for easier and more secure configuration by only requiring a NFC-capable smartphone or the like as a programming device, by removing the need for the BLE beacon to support USB cable connections or a BLE GATT peripheral role for programming, and by simplifying securing the BLE beacon from unauthorized reconfiguration by requiring physical access to the BLE beacon. In addition, using embodiments disclosed herein, selecting the correct BLE beacon to be configured from amongst several co-located BLE beacons is more reliable as compared to wireless configuration solutions.

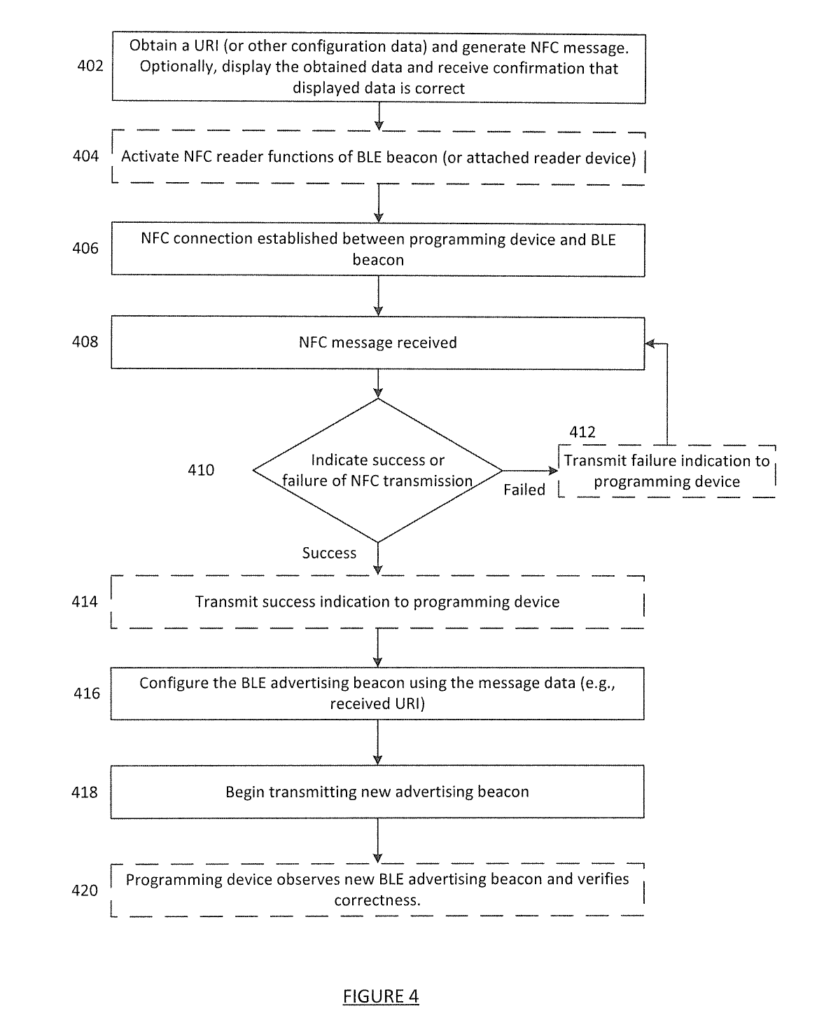

FIG. 4 illustrates a flowchart of operations for configuring a BLE advertising beacon performed by an apparatus, such as apparatus 100, in accordance with an example embodiment of the present invention. At block 302, a programming device acting as a NFC writer (for example, a NFC-capable smartphone, tablet, computer, or the like with a display screen) obtains a URI, or other data, to be used in configuring the BLE advertising beacon. For example, a programming user enters the URI on the programming device via a user interface or selects a webpage displayed in a browser. In some cases, since BLE beacon advertisements are limited in size, the programming device may utilize a URI shortener service to provide a shortened URI from the URI entered by the user.

Optionally, at block 404, the NFC reader functionality of the BLE beacon, or associated NFC reader device, may be activated, using means, such as the processor 102, memory 104, communication interface 106, beacon configuration circuitry 110, or the like. For example, in some embodiments, the NFC reader functionality of the BLE beacon may be switched off when not needed (for example, when not being used for configuration) to preserve energy and switched on during the BLE beacon configuration. In some embodiments, the NFC reader functionality of the BLE beacon may be activated by use of a physical switch.

At bock 406, the programming device, acting as a NFC writer connects to the NFC reader of the BLE beacon, or associated reader device. At block 408 the message for example comprising the URI, is received by the BLE beacon device (NFC reader) wirelessly from the programming device (NFC writer) using the NFC connection. The NFC transmission may utilize standardized NFC functionality or may use proprietary functionality. For example, in those cases where a NFC standard for encoding and transferring a type of data exists, such as for transferring a URI, the NFC standard may be used. For those cases where a NFC standard does not exist, a NFC-provided generic data exchange mechanism may be used.

At block 410, the BLE beacon device indicates whether the data transmission was successful or if the data transmission failed using suitable indicators, for example, by displaying an indication on a user interface, by lighting an appropriate LED, or the like. For example, the NFC message may include some additional data or redundant data that is suitable for transmission error detection by the BLE beacon or associated reader device.

If the data transfer failed, the BLE beacon may optionally transmit a special advertisement to signal the programming device that the transmission has failed and/or request retransmission at block 412. The programming device may then optionally update a user interface or display of the programming device to indicate the failure to the user and respond accordingly, and operation may return to block 408 to retry receiving the message.

If the data transfer succeeded, the BLE beacon may optionally transmit a special advertisement to signal the programming device that the transmission has succeeded at block 414. The programming device may then optionally update a user interface or display of the programming device to indicate the success to the user and respond to the special advertisement accordingly.

At block 416, the BLE beacon uses the received data, for example, the received URI, to configure the beacon advertisement. In the case where the BLE beacon's advertisement configuration is being updated (as opposed to an initial configuration), the BLE beacon may disregard the existing advertisement configuration and replace it using the newly transmitted data. In some embodiments, after receiving the URI, the URI may be translated into a compressed representation, for example where the substrings “http://www”, “https://www”, or the top level domain have a compressed representation.

At block 418, the BLE beacon may begin transmitting the new advertisement. Optionally in some embodiments, the programming device, for example, a smartphone, may observe the newly advertised URI, verify that it is the correct advertisement, and provide an indication such as on its user interface, at block 420.

In some embodiments, the NFC communication mechanism may be used to load an encryption key on the BLE beacon device whereby encryption may be used for BLE advertisements. As such, only observers that have the pre-shared encryption key would be able to decode and use the BLE advertisements. In such embodiments, the NFC writer and the beacon's NFC sub-systems may require the use of customized NDEF records to transmit the encryption key data.

In some embodiments, the NFC communication mechanism may be used to load other types of configuration data onto the BLE beacon. For example, the transfer mechanism may allow providing other configuration data to an application running on the BLE beacon, such as frequency for reading and broadcasting a sensor value, numeric values/thresholds for alarm conditions, and/or the like. In such embodiments, the NFC writer and the beacon's NFC sub-systems may require the use of customized NDEF records in transmitting the configuration data for the BLE beacon.

### Example Systems

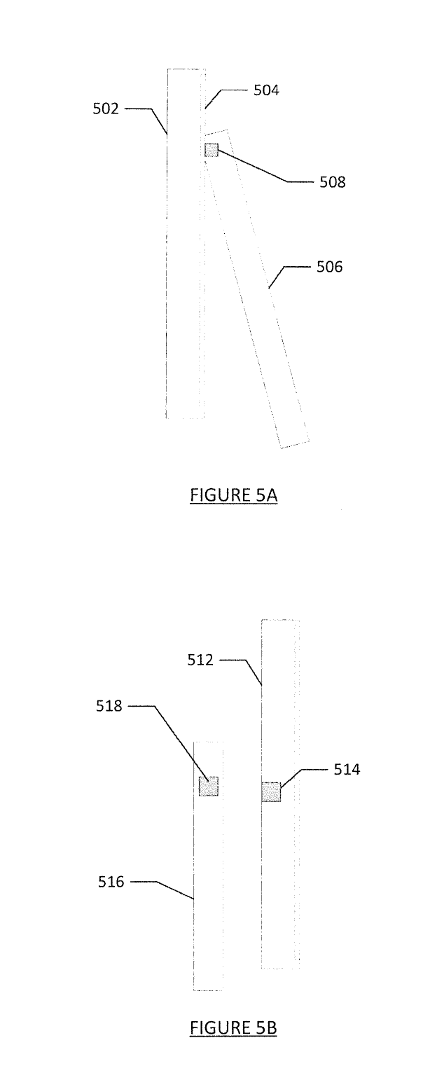

FIGS. 5A and 5B illustrate examples of systems for configuring BLE beacon advertisements in accordance with example embodiments of the present invention. FIG. 5A illustrates an example system using a flickering barcode transfer mechanism for configuring a BLE beacon advertisement. In FIG. 5A, smartphone 502 is used to obtain a URI for configuring the BLE beacon and to provide display of a flickering barcode on display 504 of the smartphone. The BLE beacon 506 is placed so that its light sensor array 508 is properly positioned above the flickering barcode displayed on display 504 of smartphone 502. The BLE beacon 506 is then able to receive and decode the data in the flickering barcode and use the data in configuring the beacon's advertisement.

FIG. 5B illustrates an example system using NFC to communicate data for configuring a BLE beacon advertisement. In FIG. 5B, NFC-capable smartphone 512 is used to obtain a URI for configuring the BLE beacon. NFC-capable smartphone 512 includes NFC writer circuitry 514 for providing a connection to a NFC reader and for transmitting messages using the NFC connection. The BLE beacon 516 includes NFC reader circuitry 518 and is placed proximate to the NFC-capable smartphone 512. A NFC connection may then be established between the NFC writer circuitry 514 and the NFC reader circuitry 518 to allow for transmission of messages comprising data for use in configuring the BLE beacon's advertisement.

As described above, FIGS. 2 and 4 illustrate operations and flowcharts of an apparatus, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the blocks with dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

### Additional Example Embodiments

A method comprising: establishing a near field communication connection with a programming device; receiving a message using the near field communication connection; configuring, using a processor, a Bluetooth low energy beacon advertisement using data included in the received message; and transmitting the configured Bluetooth low energy beacon advertisement.

The method of paragraph 69 further comprising activating a near field communication reader for use in receiving the message.

The method of either of paragraphs 69 or 70 further comprising determining if the data in the message was received successfully or if the message transmission failed and causing an indication to be provided of the success or failure of receiving the message.

The method of paragraph 71 further comprising causing transmission of a message to the programming device indicating the success or failure of receiving the data stream.

The method of any of paragraphs 69 to 72 wherein the programming device observes the configured Bluetooth low energy the configured Bluetooth low energy beacon advertisement and verifies that the advertisement is correct.

An apparatus comprising: at least one processor; and at least one memory including computer program instructions; the at least one memory and the computer program instructions configured to, with the at least one processor, cause the apparatus at least to: establish a near field communication connection with a programming device; receive a message using the near field communication connection; configure a Bluetooth low energy beacon advertisement using data included in the received message; and transmit the configured Bluetooth low energy beacon advertisement.

The apparatus of paragraph 74 further comprising the at least one memory and the computer program instructions being further configured to, with the at least one processor, cause the apparatus to activate a near field communication reader for use in receiving the message.

The apparatus of either of paragraphs 74 or 75 further comprising the at least one memory and the computer program instructions being further configured to, with the at least one processor, cause the apparatus to determine if the data in the message was received successfully or if the message transmission failed; and cause an indication to be provided of the success or failure of receiving the message.

The apparatus of paragraph 76 further comprising the at least one memory and the computer program instructions being further configured to, with the at least one processor, cause the apparatus to cause transmission of a message to the programming device indicating the success or failure of receiving the data stream.

A computer program product comprising at least one non-transitory computer-readable storage medium bearing computer program instructions embodied therein for use with a computer, the computer program instructions comprising program instructions configured to cause the computer at least to: establish a near field communication connection with a programming device; receive a message using the near field communication connection; configure a Bluetooth low energy beacon advertisement using data included in the received message; and transmit the configured Bluetooth low energy beacon advertisement.

The computer program product of paragraph 78 further comprising program instructions configured to cause the computer at least to activate a near field communication reader for use in receiving the message.

The computer program product of either of paragraphs 78 or 79 further comprising program instructions configured to cause the computer at least to determine if the data in the message was received successfully or if the message transmission failed; and cause an indication to be provided of the success or failure of receiving the message.

The computer program product of paragraph 80 further comprising program instructions configured to cause the computer at least to cause transmission of a message to the programming device indicating the success or failure of receiving the data stream.

1-49. (canceled)

50. A method comprising:
receiving a data stream encoded in a flickering barcode from a programming device;
decoding, using a processor, the received data stream; and
configuring a Bluetooth low energy beacon advertisement using the decoded data stream.

51. The method of claim 50 further comprising transmitting the configured Bluetooth low energy beacon advertisement.

52. The method of claim 50 further comprising activating a light sensor array for use in receiving the flickering barcode after receiving an indication from a user.

53. The method of claim 50 further comprising causing transmission of a Bluetooth low energy advertisement message to the programming device to begin display of the flickering barcode.

54. The method of claim 50 further comprising determining if the data stream encoded in the flickering barcode was received successfully or if the flickering barcode transmission failed; and causing an indication to be provided of the success or failure of receiving the data stream.

55. The method of claim 54 further comprising causing transmission of a Bluetooth low energy advertisement message to the programming device indicating the success or failure of receiving the data stream.

56. The method of claim 50 wherein the programming device observes the configured Bluetooth low energy beacon advertisement and verifies that the advertisement is correct, wherein the verification comprises comparing the observed advertisement with the data stream encoded in the flickering barcode by the programming device.

57. An apparatus comprising:
at least one processor;
and at least one memory including computer program instructions;
the at least one memory and the computer program instructions configured to, with the at least one processor, cause the apparatus at least to:
receive a data stream encoded in a flickering barcode from a programming device;
decode the received data stream; and
configure a Bluetooth low energy beacon advertisement using the decoded data stream.

58. The apparatus of claim 57 further comprising the at least one memory and the computer program instructions being further configured to, with the at least one processor, cause the apparatus to transmit the configured Bluetooth low energy beacon advertisement.

59. The apparatus of claim 57 further comprising the at least one memory and the computer program instructions being further configured to, with the at least one processor, cause the apparatus to activate a light sensor array for use in receiving the flickering barcode after receiving an indication from a user.

60. The apparatus of claim 57 further comprising the at least one memory and the computer program instructions being further configured to, with the at least one processor, cause the apparatus to cause transmission of a Bluetooth low energy advertisement message to the programming device to begin display of the flickering barcode.

61. The apparatus of claim 57 further comprising the at least one memory and the computer program instructions being further configured to, with the at least one processor, cause the apparatus to determine if the data stream encoded in the flickering barcode was received successfully or if the flickering barcode transmission failed; and cause an indication to be provided of the success or failure of receiving the data stream.

62. The apparatus of claim 61 further comprising the at least one memory and the computer program instructions being further configured to, with the at least one processor, cause the apparatus to cause transmission of a Bluetooth low energy advertisement message to the programming device indicating the success or failure of receiving the data stream.

63. A method comprising:
receiving data via a user interface;
generating, using a processor, a flickering barcode based on the received data; and
causing the flickering barcode to be displayed on a display, wherein the data encoded in the flickering barcode is used to configure a Bluetooth low energy beacon advertisement.

64. The method of claim 63 wherein the received data comprises a uniform resource identifier for use in configuring the Bluetooth low energy beacon advertisement.

65. The method of claim 63 further comprising:
causing the received data to be displayed; and
receiving an indication that the displayed data is the intended data for use in configuring the Bluetooth low energy beacon advertisement.

66. The method of claim 63 further comprising:
receiving a message indicating that display of the flickering barcode should be displayed, wherein the message is a special Bluetooth low energy beacon advertisement from a Bluetooth low energy beacon to be configured; and
causing the flickering barcode to be displayed on a display as a result of receiving the message.

67. The method of claim 63 further comprising:
receiving indication of whether the flickering barcode has been received properly by a Bluetooth low energy beacon; and
if the flickering barcode was received properly, causing display of the flickering barcode to be stopped; and
if the flickering barcode was not received properly, causing display of the flickering barcode to be restarted.

68. The method of claim 67 further comprising causing an indication of the success or failure of the flickering barcode transmission to be displayed on a display of a user interface.

69. The method of claim 63 further comprising:
receiving a Bluetooth low energy advertisement; and
verifying that data received in the Bluetooth low energy advertisement is correct based on a comparison to the data used to generate the flickering barcode.
